(19) United States
(12) Patent Application Publication
(10) Pub. No.: US 2022/0388145 A1
(43) Pub. Date: Dec. 8, 2022

(54) ADD-ON ELEMENT FOR A PERFORATED PLATE

(71) Applicant: Bernd Siegmund GmbH, 86507 Oberottmarshausen (DE)

(72) Inventors: BERND SIEGMUND, Grossaitingen (DE); ANDREAS RACK, Augsburg (DE)

(73) Assignee: Bernd Siegmund GmbH, 86507 Oberottmarshausen (DE)

(21) Appl. No.: 17/767,345

(22) PCT Filed: Nov. 2, 2019
(86) PCT No.: PCT/EP2019/025376

§ 371 Date: Apr. 7, 2022

(51) Int. Cl. B25H 1/00; B25H 1/08

(52) U.S. Cl. CPC B25H 1/0021; B25H 1/08

(57) ABSTRACT

An add-on element for a perforated plate having throughbores arranged in a regular grid includes an attachment part having a throughbore, an extension part, and a connecting element configured to secure the attachment part to an underside of the perforated plate by passing through a respective one of the throughbores of the perforated plate and the throughbore in the attachment part.

The invention relates to an add-on element for a perforated plate having throughbores arranged in a regular grid.

Such perforated plates find application, for example, in work tables that are compatible with the accessory of welding and clamping table systems. Welding and clamping table systems are based on a flexible modular system comprised of a combination of system bores and compatible clamping elements. The clamping elements include stops, angles, bolts, clamps, prisms, supports and further accessory. For example, angles with clamping bolts are hereby mounted to the work area of the perforated plate, but this reduces the usable work area of the perforated plate, which is small compared to welding and clamping tables. In addition, it may be necessary to extend the work area of the perforated plate at least partially. In the case of welding and clamping tables that have side panels with throughbores, angles with clamping bolts are attached to the side panels to extend the work area. This is not possible for a perforated plate without side panels.

The invention is therefore based on the problem to provide an add-on element for a perforated plate so as to be able to improve the possible applications of the perforated plate.

This object is solved with the features of the independent claim. Advantageous configurations of the invention are set forth in the dependent claims.

In the case of the add-on element according to the invention for a perforated plate, which has throughbores arranged in a regular grid, provision is made for the add-on element to include an attachment part and an extension part, with the attachment part having at least one throughbore and securable to the underside of the perforated plate by at least one connecting element which extends through a respective throughbore of the perforated plate and a throughbore of the attachment part. By securing the attachment part to the underside of the perforated plate with the aid of the throughbores, the entire work area of the perforated plate remains available and is additionally expanded by the extension part. An example of a connecting element can be a countersunk bolt, which is a component of the accessory of welding and clamping table systems. The countersunk bolt is used as a concealed connection between structural parts. The head thereof disappears in the depression of the bore so that nothing protrudes from the work area of the perforated plate.

In practice, the surfaces of perforated plates are usually not worked on so as to have a relatively high thickness deviation of up to 0.5 mm. As a result, perforated plates do not have a precisely defined surface like e.g. welding and clamping tables. In order to be able to align the perforated plate and the add-on element with respect to each other, it is proposed that the attachment part has at least two threaded bores into each of which a set screw can be screwed, so that the set screw can push against the underside of the perforated plate and enable a variable adjustment of the distance between attachment part and perforated plate. The threaded bores can hereby be configured as bores with self-locking internal thread, but this is not necessarily required. The set screws can be designed according to the ISO 4026 standard with cone point and hexagon socket. As an alternative, the use of regular screws is also possible. The set screws push against the underside of the perforated plate and enable the orientation of the add-on element through variable adjustment of the distance to the perforated plate. The advantage of this solution is an inexpensive and simple possibility of aligning the surface of the add-on element to the work area of the perforated plate, without the need to treat the work areas.

According to an advantageous configuration, the extension part has throughbores arranged in a regular grid. As a result, clamping elements can also be used on the extension part.

The extension part can be configured as horizontal extension of the work area of the perforated plate, so that an expansion of the work area of the perforated plate is made possible.

In addition, the extension part can also be configured as a work area that is vertical to the work area of the perforated plate. The extension part then forms an angle on one side of the perforated plate, without restricting the work area of the perforated plate.

To increase the stability of the add-on element, the add-on element can include at least one strut by which the attachment part and extension part are stiffened.

Exemplary embodiments of the invention will be explained in more detail with reference to the drawing. It is shown in:

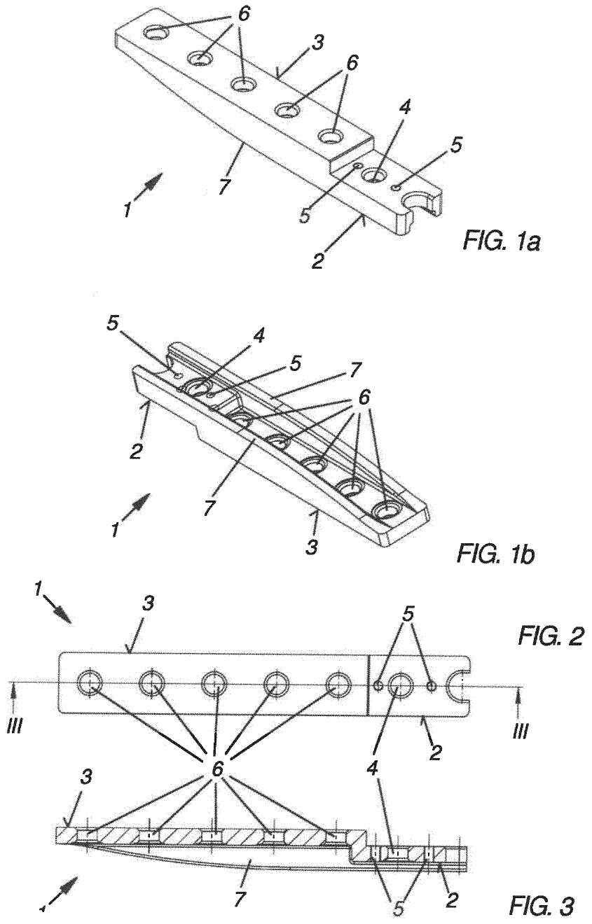

FIGS. 1a and 1b perspective views of an add-on element,

FIG. 2 a top view of the add-on element,

FIG. 3 a section along line III-III of FIG. 2,

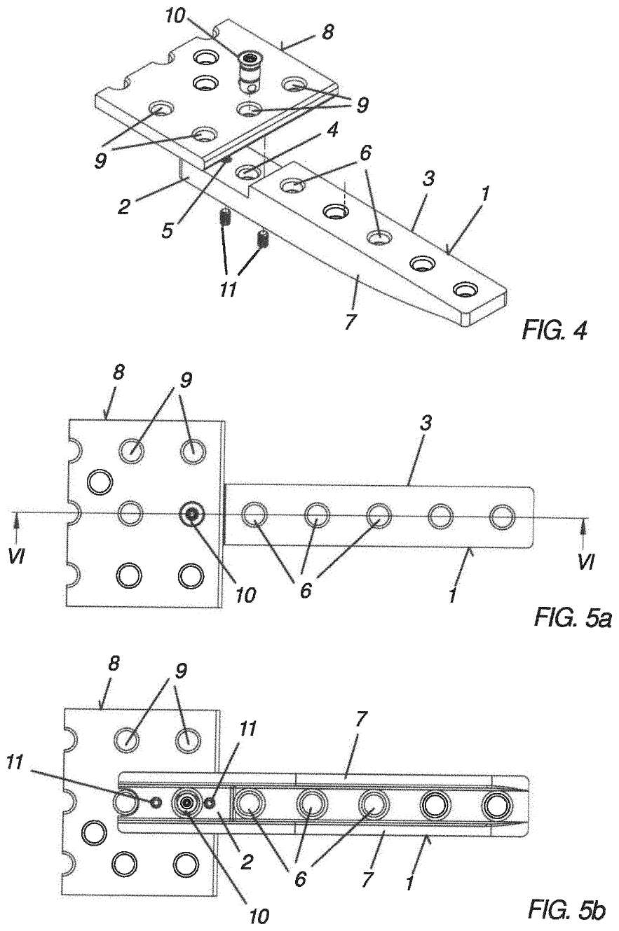

FIG. 4 an exploded view of the add-on element on a perforated plate,

FIGS. 5a and 5b a top view and a bottom view of the add-on element on a perforated plate,

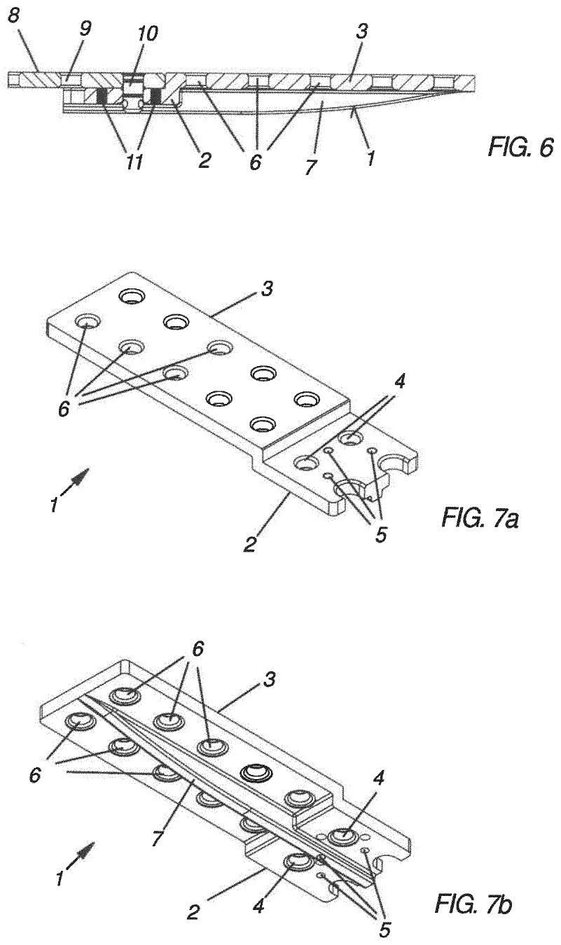

FIG. 6 a section along line VI-VI of FIG. 5a,

FIGS. 7a and 7b perspective views of another add-on element,

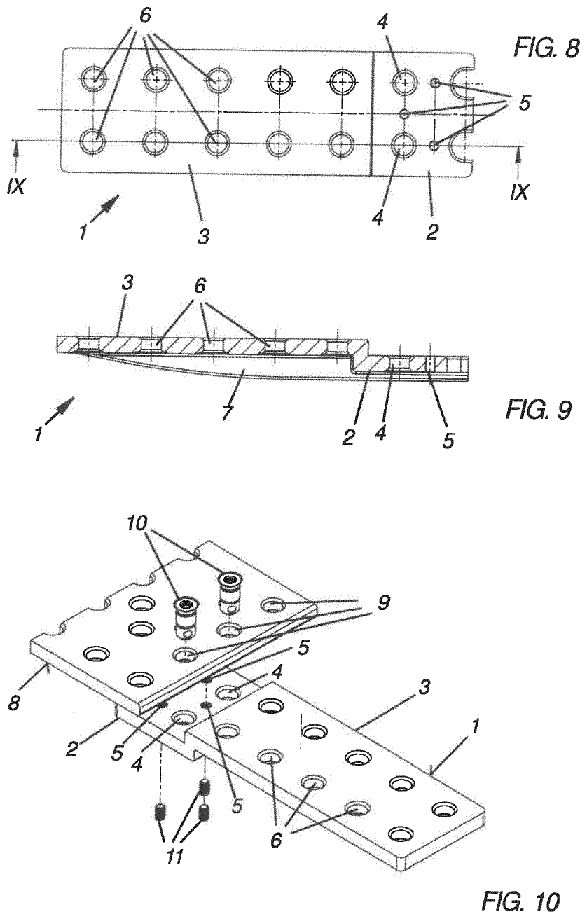

FIG. 8 a top view of the add-on element,

FIG. 9 a section along line IX-IX of FIG. 8,

FIG. 10 an exploded view of the add-on element on a perforated plate,

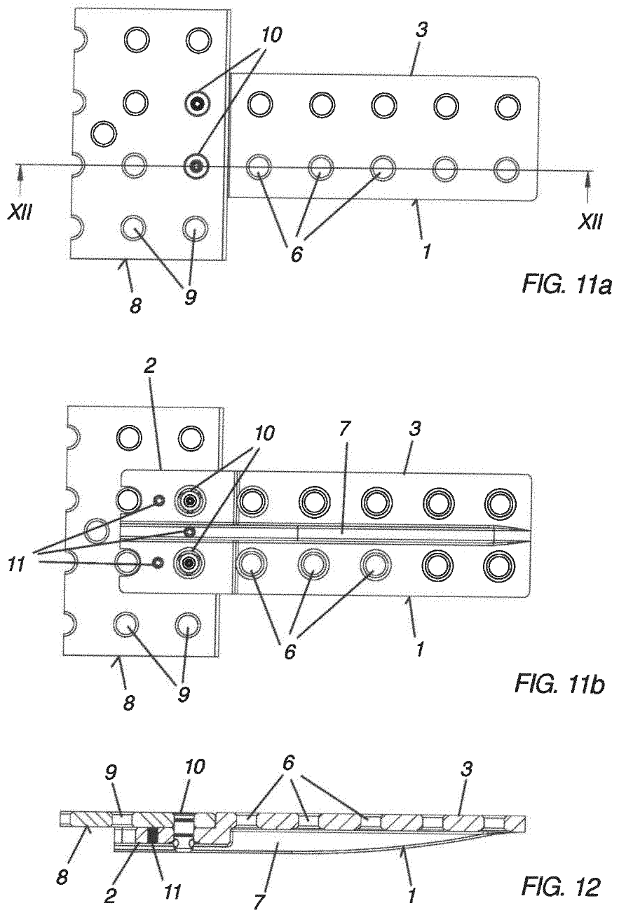

FIGS. 11a and 11b a top view and a bottom view of the add-on element on a perforated plate,

FIG. 12 a section along line XII-XII of FIG. 11a,

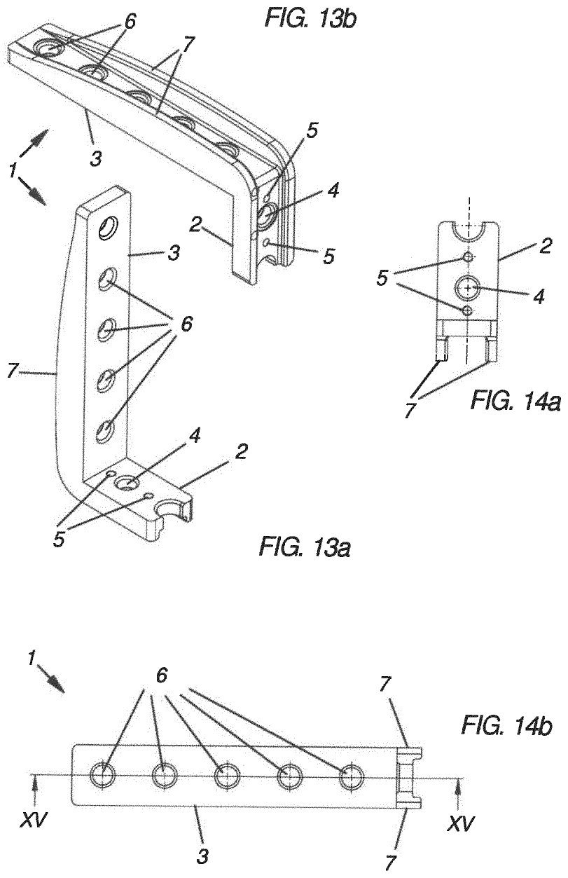

FIGS. 13a and 13b perspective views of another add-on element,

FIG. 14a a top view of the attachment part of the add-on element,

FIG. 14b a top view of the extension part of the add-on element,

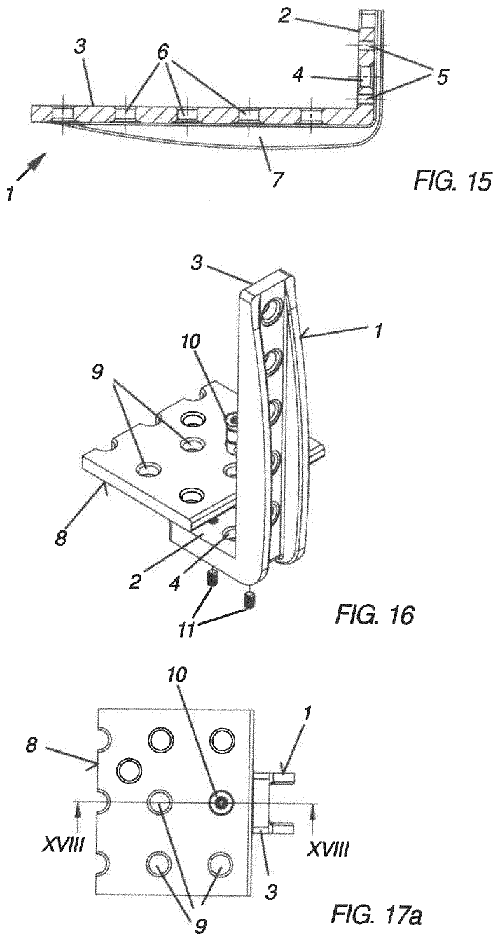

FIG. 15 a section along line XV-XV of FIG. 14b,

FIG. 16 an exploded view of the add-on element on a perforated plate,

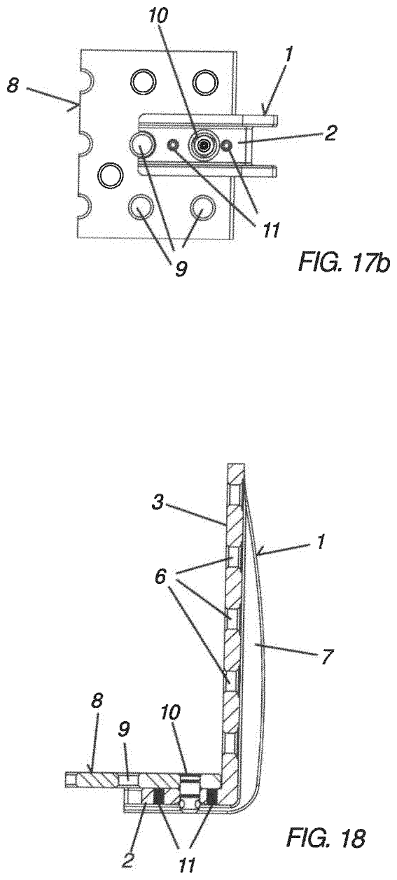

FIGS. 17a and 17b a top view and a bottom view of the add-on element on a perforated plate,

FIG. 18 a section along line XVIII-XVIII of FIG. 17a.

FIGS. 1a, 1b, 2 and 3 show a first example of an add-on element 1. The add-on element 1 includes an attachment part 2 and an extension part 3. The attachment part 2 has a throughbore 4 and two threaded bores 5 with self-locking internal thread. It is understood that the threaded bores 5 are not necessarily required, when the dimensional accuracy of the structural parts is so good that an adjustment of a distance between the attachment part 2 and a perforated plate becomes unnecessary.

The extension part 3 has throughbores 6 arranged in a regular grid and is configured as a horizontal extension of the work area of a perforated plate.

The add-on element 1 has two struts 7 to stiffen the attachment part 2 and the extension part 3. Depending on the requirements for stiffness of the add-on element 1 and in dependence on the material of the add-on element 1, the need for struts 7 could also be dispensed with.

The use of the add-on element 1 on a perforated plate is explained in more detail with reference to FIGS. 4, 5a, 5b and 6. The attachment part 2 is mounted to the underside of a perforated plate 8, which has throughbores 9 arranged in a regular grid. For this purpose, a countersunk bolt 10 as connecting element passes through a respective throughbore 9 of the perforated plate 8 and the throughbore 4 of the attachment part 2.

A set screw 11 is screwed into each of the threaded bores 5 and pushes against the underside of the perforated plate 8. By adjusting the set screws 11, a variable adjustment of the distance between the attachment part 2 and the perforated plate 8 becomes possible in order to align the surfaces of the extension part 3 and the perforated plate 8 in relation to one another. It is understood that the set screws 11 are not necessarily required, when the dimensional accuracy of the components is so good that it is not necessary to adjust a distance between the attachment part 2 and a perforated plate.

As is readily apparent from FIG. 6, the extension part 3 forms a horizontal extension of the work area of the perforated plate 8.

FIGS. 7a, 7b, 8 and 9 show a second example of an add-on element 1. The add-on element 1 includes an attachment part 2 and an extension part 3. The attachment part 2 has two throughbores 4 and three threaded holes 5 with self-locking internal threads. It is understood that the threaded holes 5 are not necessarily required, when the dimensional accuracy of the components is so good that it is not necessary to set a distance between the attachment part 2 and a perforated plate.

The extension part 3 has throughbores 6 arranged in a regular grid and is designed as a horizontal extension of the work area of a perforated plate.

The add-on element 1 has a strut 7 to stiffen the attachment part 2 and extension part 3. Depending on the requirements with respect to stiffness of the add-on element 1 and in dependence on the material of the add-on element 1, the need for a strut 7 could also be dispensed with.

The use of the add-on element 1 on a perforated plate will be explained in more detail with reference to FIGS. 10, 11a, 11b and 12. The attachment part 2 is secured to the underside of a perforated plate 8, which has throughbores 9 arranged in a regular grid. For this purpose, countersunk bolts 10 as connecting element respectively pass through a throughbore 9 of the perforated plate 8 and a throughbore 4 of the attachment part 2.

A set screw 11 is screwed into each of the threaded holes 5 and pushes against the underside of the perforated plate 8. By adjusting the set screws 11. it is possible to variably adjust the distance between attachment part 2 and perforated plate 8 in order to align the surfaces of the extension part 3 and the perforated plate 8 in relation to one another. It is understood that the set screws 11 are not necessarily required, when the dimensional accuracy of the components is so good that it is not necessary to adjust a distance between the attachment part 2 and a perforated plate.

As is readily apparent from FIG. 12, the extension part 3 forms a horizontal extension of the work area of the perforated plate 8.

FIGS. 13a, 13b, 14a, 14b and 15 show a third example of an add-on element 1. The add-on element 1 includes an attachment part 2 and an extension part 3. The attachment part 2 has a throughbore 4 and two threaded holes 5 with self-locking internal thread. It is understood that the threaded holes 5 are not necessarily required, when the dimensional accuracy of the components is so good that it is not necessary to adjust a distance between the attachment part 2 and a perforated plate.

The extension part 3 has throughbores 6 arranged in a regular grid and is designed as a work area that is vertical to the work area of a perforated plate.

The add-on element 1 has two struts 7 to stiffen the attachment part 2 and the extension part 3, Depending on the requirements for stiffness of the add-on element 1 and in dependence on the material of the add-on element 1, the need for struts 7 could also be dispensed with.

The use of the add-on element 1 on a perforated plate is explained in more detail with reference to FIGS. 16, 17, 17b and 18. The attachment part 2 is secured to the underside of a perforated plate 8, which has throughbores 9 arranged in a regular grid. For this purpose, a countersunk bolt 10 as connecting element passes through a respective throughbore 9 of the perforated plate 8 and the throughbore 4 of the attachment part 2.

A set screw 11 is screwed into each of the threaded holes 5 and pushes against the underside of the perforated plate 8. By adjusting the set screws 11, it is possible to variably adjust the distance between the attachment part 2 and the perforated plate 8 in order to align the surfaces of the extension part 3 and the perforated plate 8 in relation to one another. It is understood that the set screws 11 are not necessarily required, when the dimensional accuracy of the components is so good that it is not necessary to adjust a distance between the attachment part 2 and a perforated plate.

As is readily apparent from FIG. 18, the extension part 3 forms a work area that is vertical to the work area of the perforated plate 8. The extension part 3 thus forms an angle located on one side of the perforated plate 8, without restricting the work area of the perforated plate 8.

### LIST OF REFERENCE SIGNS

1 add-on element

2 attachment part

3 extension part

4 throughbore in 2

5 threaded bore in 2

6 throughbores in 3

7 strut

8 perforated plate

9 throughbore of 8

10 countersunk bolt

11 set screw

What is claimed is:

1.-6. (canceled)

7. An add-on element for a perforated plate having throughbores arranged in a regular grid, comprising:
an attachment part having a throughbore;
an extension part; and
a connecting element configured to secure the attachment part to an underside of the perforated plate by passing through a respective one of the throughbores of the perforated plate and the throughbore in the attachment part.

8. The add-on element of claim 7, wherein the attachment part has at least two threaded bores, and further comprising a set screw screwable in one of the at least two threaded bores and a set screw screwable in the other one of the at least two threaded bores, said set screws when screwed into the at least two threaded bores pushing against the underside of the perforated plate and capable of variably adjusting a distance between the attachment part and the perforated plate.

9. The add-on element of claim 7, wherein the extension part has throughbores arranged in a regular grid.

10. The add-on element of claim 7, wherein the extension part is designed as a horizontal extension of a work area of the perforated plate.

11. The add-on element of claim 7, wherein the extension part is designed as a work area that is vertical to a work area of the perforated plate.

12. The add-on element of claim 7, further comprising a strut configured to stiffen the attachment part and the extension part.
